(19) United States
(12) Patent Application Publication
(10) Pub. No.: US 2013/0168907 A1
(43) Pub. Date: Jul. 4, 2013

(54) VIBRATION ISOLATOR

(71) Applicants: Masaaki MIZOBE, Kurashiki (JP); Kazuo MIYAKE, Kurashiki (JP)

(72) Inventors: Masaaki MIZOBE, Kurashiki (JP); Kazuo MIYAKE, Kurashiki (JP)

(73) Assignee: Kurashiki Kako Co., Ltd., Kurashiki (JP)

(21) Appl. No.: 13/338,561

(22) Filed: Dec. 28, 2011

(51) Int. Cl. F16F 7/00

(52) U.S. Cl. 267/141

(57) ABSTRACT

A torque rod includes a stopper. The stopper includes a first guide portion sloped to a top-bottom direction of a vehicle body on one side in the top-bottom direction of the vehicle body relative to a reference axis, and a second guide portion sloped to the top-bottom direction of the vehicle body in an opposite direction of the slope of the first guide portion on the other side in the top-bottom direction of the vehicle body relative to the reference axis.

### CROSS-REFERENCE TO RELATED APPLICATION

This application claims priority to Japanese Patent Application No. 2010-153215 filed on Jul. 5, 2010, the disclosure of which including the specification, the drawings, and the claims is hereby incorporated by reference in its entirety.

### BACKGROUND

A technique disclosed in the present specification relates to a vibration isolator connecting a supported body such as a power plant of an automobile and a vehicle body together.

Conventionally, e.g., a front-engine front-drive (FF) type vehicle has typically employed a so-called “transversely-mounted” power plant which includes an engine and a transmission connected together in series and is transversely arranged in an engine room so that a long-side direction of the power plant is along a vehicle width direction. As one example of the transversely-mounted power plant, there is a so-called “pendulum-mounted” power plant. In the pendulum-mounted power plant, both end portions of the power plant in a long-side direction thereof are elastically supported on side frames of a vehicle by vibration isolating mounts, and the two vibration isolating mounts are arranged in positions higher than a principal axis of inertia (roll axis) of the power plant. As a result, the pendulum-mounted power plant is swingably supported, like pendulums, around a spindle connecting support points of loads of the vibration isolating mounts. When great drive reaction force acts, e.g., by abrupt acceleration/deceleration of an automobile, the pendulum-mounted power plant tends to generate, like pendulums, a big swing in a front-back direction of a vehicle body, but such a swing in the front-back direction of the vehicle body is restricted by a structure in which a lower end portion of the power plant and a vehicle sub-frame positioned on a back side of the vehicle body relative to the power plant are connected together through a torque rod (vibration isolator) disclosed in, e.g., Japanese Patent No. 4046072.

The torque rod disclosed in Japanese Patent No. 4046072 includes a bracket. In both end portions of the torque rod in a long-side direction thereof, the bracket includes a first cylindrical portion having a relatively-small cylinder hole, and a second cylindrical portion opening in the same direction as a direction in which the cylinder hole of the first cylindrical portion opens and having a relatively-large cylinder hole. A first inner cylinder is arranged in the cylinder hole of the first cylindrical portion, and the first inner cylinder and the first cylindrical portion are connected together by a rubber elastic body. The cylinder hole of the second cylindrical portion has substantially an octagon shape as viewed in a cylinder axis direction, and a second inner cylinder is arranged in substantially a center portion of the cylinder hole of the second cylindrical portion so as to be parallel to a cylinder axis of the first inner cylinder. In such a state, the second inner cylinder and the second cylindrical portion are connected together by an elastic body. A through-hole penetrating the elastic body in a cylinder axis direction of the second inner cylinder is formed on each side of the elastic body in the long-side direction of the torque rod (in a direction perpendicular to a cylinder axis of the second inner cylinder) relative to the second inner cylinder. This forms main spring portions each extending from the second inner cylinder to the second cylindrical portion in substantially a radial direction.

When the torque rod configured as described above is employed for the pendulum-mounted power plant, the first inner cylinder is connected to the power plant (supported body) and the second inner cylinder is connected to the sub-frame (vehicle body) of a vehicle in a state in which the long-side direction of the torque rod is along the front-back direction of the vehicle body (along a main load-input direction) and a short-side direction perpendicular to the long-side direction of the torque rod is along a top-bottom direction of the vehicle body.

A mounting portion which is part of an inner circumferential surface of the octagon second cylindrical portion facing the second inner cylinder on a side closer to the first cylindrical portion is formed so as to be substantially flat in the short-side direction of the torque rod. A stopper which is part of the rubber elastic body is provided on the mounting portion so as to have substantially a uniform thickness. Thus, the stopper is formed so as to face the second inner cylinder in the long-side direction of the torque rod with the through-hole being interposed between the stopper and the second inner cylinder and to be substantially flat in the short-side direction of the torque rod (to be substantially flat in a direction perpendicular to the main load-input direction). Upon great relative displacement of the second inner cylinder and the second cylindrical portion in the long-side direction of the torque rod, the stopper comes into contact with the second inner cylinder (the stopper comes into contact with, to be more exact, part of the elastic body surrounding the second inner cylinder, and the second inner cylinder and the part of the elastic body surrounding the second inner cylinder may be hereinafter collectively referred to as a “second inner cylinder portion”). Thus, the stopper serves a function to restrict the relative displacement of the second inner cylinder and the second cylindrical portion in the long-side direction of the torque rod to a predetermined amount.

### SUMMARY

The second cylindrical portion having the polygonal cylinder hole as viewed in the cylinder axis direction thereof as in the torque rod disclosed in Japanese Patent No. 4046072 is advantageous to expansion of an adjustable range of a spring characteristic, extension of a free length of a main spring, and expansion of variety of stopper shapes.

However, the inventors of the present disclosure have found that, in the torque rod having the polygonal cylinder hole, when a load is input to the torque rod to generate great relative displacement of the second cylindrical portion and the second inner cylinder in the front-back direction of the vehicle body, a phenomenon may occur, in which the second cylindrical portion and the second inner cylinder are displaced by an amount beyond the maximum stroke amount set by the stopper. Since the relative displacement by the amount beyond the maximum stroke amount causes displacement of the power plant by an amount greater than a preset amount, there is a possibility that the power plant contacts other components or other regions.

The technique disclosed in the present specification has been made in view of the foregoing, and it is an objective of the technique to, in a vibration isolator connecting a supported body such as a power plant and a vehicle body together, ensure reduction or prevention of relative displacement by an amount beyond the preset maximum stroke amount.

Study on the foregoing phenomenon by the inventors of the present disclosure shows that, in the vibration isolator having the polygonal cylinder hole (particularly in the vibration isolator in which the mounting portion on which the stopper is provided is substantially flat in the direction perpendicular to the main load-input direction), if the second cylindrical portion and the second inner cylinder are relatively displaced along the main load-input direction (i.e., if the second inner cylinder is relatively displaced on a reference axis extending in the main load-input direction so as to connect the cylinder axis of the first inner cylinder and a cylinder axis of the second cylindrical portion together, and comes into contact with the mounting portion (stopper) perpendicular to the main load-input direction), further relative displacement of the second inner cylinder is restricted after the second inner cylinder and the mounting portion contact each other, thereby avoiding an increase in stroke amount beyond such a contact point.

The inventors of the present disclosure have also found that, when deviation of the second inner cylinder from the reference axis is caused in association with deviation of a direction of a load to be input to the vibration isolator, and then the second inner cylinder is relatively displaced and comes into contact with the stopper provided on the mounting portion, the bracket turns, thereby further relatively displacing the second inner cylinder in the main load-input direction by a turning amount of the bracket.

Thus, the inventors of the present disclosure had focused on reduction or prevention of the turning of the bracket even if the second inner cylinder is relatively displaced in association with the deviation thereof from the reference axis. As a result, the inventors of the present disclosure proposed the technique disclosed in the present specification.

The technique disclosed in the present specification is intended for a vibration isolator for connecting a supported body and a vehicle body.

The vibration isolator includes a bracket including a first cylindrical portion arranged on a side closer to the supported body, a second cylindrical portion arranged on a side closer to the vehicle body so as to be spaced from the first cylindrical portion in a main load-input direction, and a connection portion connecting the first and second cylindrical portions; a first inner cylinder arranged in a cylinder hole of the first cylindrical portion, elastically connected to the first cylindrical portion, and connected to the supported body; a second inner cylinder arranged in a cylinder hole of the second cylindrical portion so as to be parallel to a cylinder axis of the first inner cylinder and connected to the vehicle body; a rubber elastic body connecting the second cylindrical portion and the second inner cylinder; and a stopper provided on a mounting portion which is part of an inner circumferential surface of the second cylindrical portion and faces the second inner cylinder in the main load-input direction, and, when the second cylindrical portion and the second inner cylinder are relatively displaced in the main load-input direction in association with load input, contacting a second inner cylinder portion to restrict relative displacement of the second cylindrical portion and the second inner cylinder. The stopper includes a first guide portion which, on one side in a direction perpendicular to the main load-input direction relative to a reference axis extending in the main load-input direction so as to connect the cylinder axis of the first inner cylinder and a cylinder axis of the second cylindrical portion together, extends from a side farther from the reference axis toward the reference axis so as to be apart from the cylinder axis of the second cylindrical portion and is sloped to the direction perpendicular to the main load-input direction, and a second guide portion which, on the other side in the direction perpendicular to the main load-input direction relative to the reference axis, is sloped to the direction perpendicular to the main load-input direction in an opposite direction to a slope of the first guide portion. When the second inner cylinder portion contacts the first or second guide portion of the stopper in association with the load input, the second inner cylinder portion relatively moves toward the reference axis along the first or second guide portion.

If the elastic body is integrally provided on a surface of the second inner cylinder, the “second inner cylinder portion” indicates not only the second inner cylinder itself but also the elastic body.

According to the foregoing configuration, when, e.g., a load from the supported body (a load in the main load-input direction) is input to the vibration isolator, the second cylindrical portion and the second inner cylinder are relatively displaced in the main load-input direction, thereby contacting the second inner cylinder and the stopper to each other.

On the other hand, when the second inner cylinder is relatively displaced in association with deviation of the second inner cylinder from the reference axis toward one side in the direction perpendicular to the main load-input direction relative to the reference axis, the second inner cylinder contacts the first guide portion of the stopper. When the second inner cylinder is deviated toward the other side in the direction perpendicular to the main load-input direction relative to the reference axis, the second inner cylinder contacts the second guide portion of the stopper. The first guide portion extends from the side farther from the reference axis toward the reference axis so as to be apart from the cylinder axis of the second cylindrical portion and is sloped to the direction perpendicular to the main load-input direction. Thus, when the second inner cylinder portion contacts the first guide portion, the second inner cylinder portion relatively moves along the first guide portion, and is finally positioned on the reference axis. In addition, the second guide portion is sloped to the direction perpendicular to the main load-input direction in the opposite direction of the slope of the first guide portion. Thus, when the second inner cylinder portion contacts the second guide portion, the second inner cylinder portion relatively moves along the second guide portion, and is finally positioned on the reference axis.

When the second inner cylinder is relatively displaced in association with the deviation of the second inner cylinder from the reference axis and contacts the first or second guide portion, the first or second guide portion corrects the position of the second inner cylinder to be on the reference axis, thereby avoiding turning of the bracket. As a result, reduction or prevention of the relative displacement of the second inner cylinder by an amount beyond the maximum stroke amount is ensured.

The vibration isolator includes a bracket including a first cylindrical portion arranged on a side closer to the supported body, a second cylindrical portion arranged on a side closer to the vehicle body so as to be spaced from the first cylindrical portion in a main load-input direction, and a connection portion connecting the first and second cylindrical portions; a first inner cylinder arranged in a cylinder hole of the first cylindrical portion, elastically connected to the first cylindrical portion, and connected to the supported body; a second inner cylinder arranged in a cylinder hole of the second cylindrical portion so as to be parallel to a cylinder axis of the first inner cylinder and connected to the vehicle body; a rubber elastic body connecting the second cylindrical portion and the second inner cylinder; and a stopper provided on a mounting portion which is part of an inner circumferential surface of the second cylindrical portion and faces the second inner cylinder in the main load-input direction, and, when the second cylindrical portion and the second inner cylinder are relatively displaced in the main load-input direction in association with load input, contacting a second inner cylinder portion to restrict relative displacement of the second cylindrical portion and the second inner cylinder. The mounting portion includes a first mounting surface which, on one side in a direction perpendicular to the main load-input direction relative to a reference axis extending in the main load-input direction so as to connect the cylinder axis of the first inner cylinder and a cylinder axis of the second cylindrical portion together, extends from a side farther from the reference axis toward the reference axis so as to be apart from the cylinder axis of the second cylindrical portion and is sloped to the direction perpendicular to the main load-input direction, and a second mounting surface which, on the other side in the direction perpendicular to the main load-input direction relative to the reference axis, is sloped to the direction perpendicular to the main load-input direction in an opposite direction to a slope of the first mounting surface. The stopper is provided along the first and second mounting surfaces. When the second inner cylinder portion contacts the stopper in association with the load input, the second inner cylinder portion relatively moves toward the reference axis along the first or second mounting surface.

If the elastic body is integrally provided on a surface of the second inner cylinder, the “second inner cylinder portion” indicates not only the second inner cylinder itself but also the elastic body.

According to the foregoing configuration, when the second inner cylinder is relatively displaced in association with deviation of the second inner cylinder from the reference axis toward one side in the direction perpendicular to the main load-input direction, the second inner cylinder contacts the stopper on the first mounting surface of the mounting portion. When the second inner cylinder is relatively displaced in association with deviation of the second inner cylinder toward the other side in the direction perpendicular to the main load-input direction, the second inner cylinder contacts the stopper on the second mounting surface of the mounting portion. As in the first guide portion, the first mounting surface extends from the side farther from the reference axis toward the reference axis so as to be apart from the cylinder axis of the second cylindrical portion and is sloped to the direction perpendicular to the main load-input direction. Thus, when the second inner cylinder contacts the stopper on the first mounting surface, the second inner cylinder relatively moves on the stopper along the first mounting surface, and is finally positioned on the reference axis. In addition, the second mounting surface is sloped to the direction perpendicular to the main load-input direction in the opposite direction of the slope of the first mounting surface. Thus, after the second inner cylinder contacts the second mounting surface, the second inner cylinder relatively moves on the stopper along the second mounting surface, and is finally positioned on the reference axis.

When the second inner cylinder is relatively displaced in association with the deviation of the second inner cylinder from the reference axis, the first or second mounting surface corrects the position of the second inner cylinder to be on the reference axis, thereby avoiding turning of the bracket. As a result, reduction or prevention of the relative displacement of the second inner cylinder by an amount beyond the maximum stroke amount is ensured.

The second inner cylinder, the second cylindrical portion, and the rubber elastic body are preferably formed by integral vulcanization molding.

As one of methods for arranging a second inner cylinder in a cylinder hole of a second cylindrical portion, there is a method for pressing a rubber bush including a second inner cylinder and an outer cylinder into a second cylindrical portion. In the method for pressing the rubber bush into the second cylindrical portion, the shape of the cylinder hole of the second cylindrical portion should be in a circular shape or an oval shape as viewed in a cylinder axis direction in order to press the rubber bush into the second cylindrical portion. On the other hand, since the second cylindrical portion, the second inner cylinder, and the rubber elastic body are formed by the integral vulcanization molding, the cylinder hole of the second cylindrical portion is not necessarily in the circular shape or the oval shape as viewed in the cylinder axis direction, and can be in a desired shape. Thus, e.g., the second cylindrical portion can be realized, which has the polygonal cylinder hole and is advantageous to expansion of an adjustable range of a spring characteristic, extension of a free length of a main spring, and expansion of variety of stopper shapes.

### BRIEF DESCRIPTION OF THE DRAWINGS

FIG. 1 is a perspective view illustrating a schematic configuration of an engine mount system of an automobile.

FIG. 2 is a side view of a torque rod of a first example embodiment.

FIG. 3 is a side view of a torque rod of a second example embodiment.

### DETAILED DESCRIPTION

Example embodiments will be described below in detail with reference to the drawings. Note that the example embodiments will be set forth merely for purposes of preferred examples in nature.

### First Example Embodiment

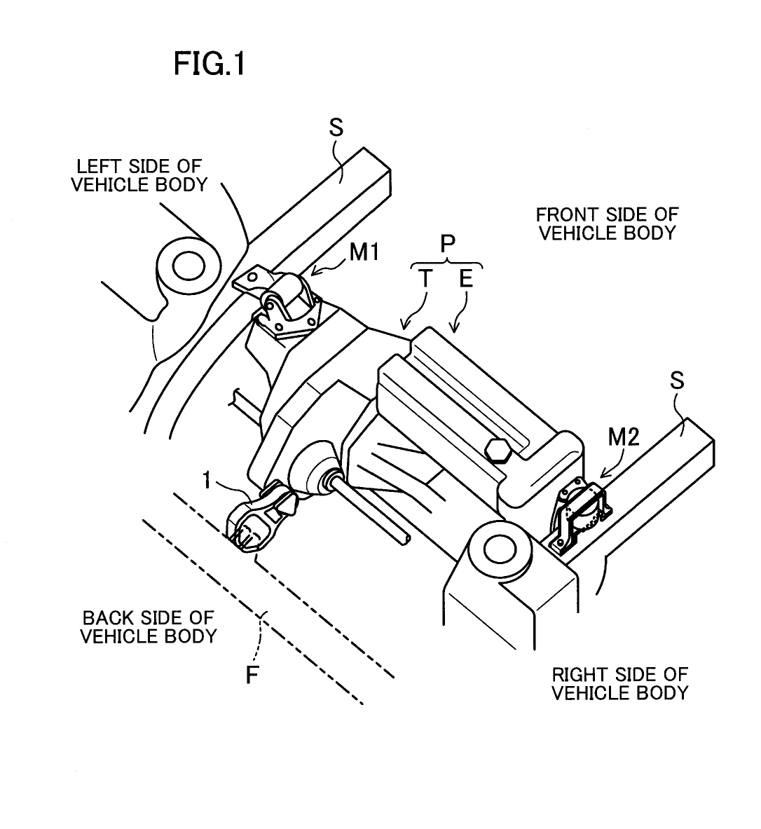

FIG. 1 is a perspective view illustrating a schematic configuration of an engine mount system of an automobile of an example embodiment. In FIG. 1, a reference character “P” represents a power plant in which an engine E and a transmission T are connected together in series.

The power plant P is transversely arranged in an engine room so that a long-side direction of the power plant P is along a vehicle width direction, and is elastically supported on side frames S of a vehicle by vibration isolating mounts M1, M2 respectively arranged in both end portions of the power plant P in the long-side direction thereof. Each of the two vibration isolating mounts M1, M2 is arranged in a position higher than a principal axis of inertia (roll axis) of the power plant P. This allows the power plant P to swing, like a pendulum, around a spindle connecting support points of loads of the two vibration isolating mounts M1, M2.

In the engine mount system, when great drive reaction force acts, e.g., by abrupt acceleration/deceleration of the automobile, the power plant P tends to generate, like pendulums, a big swing in a front-back direction of a vehicle body, but such a swing in the front-back direction of the vehicle body is restricted by a structure in which a lower end portion of the power plant P and a vehicle sub-frame F positioned on a back side of the vehicle body relative to the power plant P are connected together through a torque rod 1. The power plant P is a supported body, and the sub-frame F is the vehicle body. In addition, in the engine mount system, a main load-input direction is along the front-back direction of the vehicle body, and a direction perpendicular to the front-back direction of the vehicle body is along a top-bottom direction of the vehicle body.

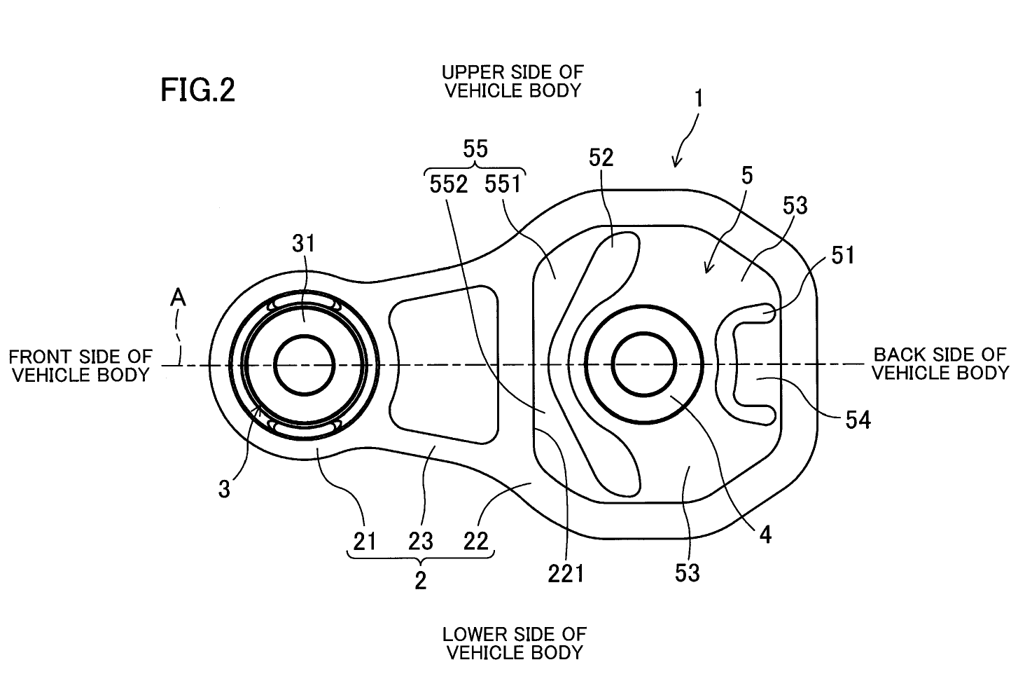

As illustrated in FIG. 2, the torque rod 1 includes a bracket 2 having substantially a gourd shape as viewed from side. The bracket 2 includes a first cylindrical portion 21 having a relatively-small cylinder hole, a second cylindrical portion 22 arranged so as to be spaced from the first cylindrical portion 21 in the main load-input direction (i.e., the front-back direction of the vehicle body) and having a relatively-large cylinder hole opening in the same direction as a direction in which the cylinder hole of the first cylindrical portion 21 opens, and a connection portion 23 connecting the first cylindrical portion 21 and the second cylindrical portion 22 together. The first cylindrical portion 21 is connected to the power plant P, and the second cylindrical portion 22 is connected to the sub-frame F.

The first cylindrical portion 21 is in a circular cylindrical shape, and a rubber bush 3 is concentrically fitted into the cylinder hole of the first cylindrical portion 21.

The rubber bush 3 includes a first inner cylinder 31 and a rubber elastic body integrally provided around the first inner cylinder 31.

The first inner cylinder 31 is a circular cylindrical member. The first inner cylinder 31 is connected to the lower end portion of the power plant P by, e.g., bolts (not shown in the figure) inserted into a cylinder hole of the first inner cylinder 31, thereby connecting the first cylindrical portion 21 of the torque rod 1 to the power plant P.

The second cylindrical portion 22 is formed so that the cylinder hole thereof has an octagon shape as viewed from side, and a second inner cylinder 4 is arranged in substantially a center portion of the cylinder hole of the second cylindrical portion 22 so as to be parallel to a cylinder axis of the first inner cylinder 31. In such a state, the second inner cylinder 4 and the second cylindrical portion 22 are connected together by a rubber elastic body 5. In order to connect the second inner cylinder 4 and the second cylindrical portion 22 together by the rubber elastic body 5, e.g., integral vulcanization molding may be performed. Specifically, the integral vulcanization molding may be performed as follows. After a bracket 2 is arranged in a mold for injection molding, a second inner cylinder 4 is arranged in a second cylindrical portion 22 of the bracket 2. Then, after clamping of the mold, an unvulcanized rubber elastic body 5 is injected between the second inner cylinder 4 and the second cylindrical portion 22, and the rubber elastic body 5, the second inner cylinder 4, and the second cylindrical portion 22 are vulcanized and bonded together by heat vulcanization. The integral vulcanization molding allows an increase in degree of freedom of the shape of the cylinder hole of the second cylindrical portion 22 without limiting such a shape to, e.g., a circular shape and an oval shape. The second cylindrical portion 22 having the polygonal cylinder hole as viewed in a cylinder axis direction thereof is advantageous to expansion of an adjustable range of a spring characteristic, extension of a free length of a main spring, and expansion of variety of stopper shapes. The cylinder hole of the second cylindrical portion 22 is in the octagon shape in the present embodiment, but the present disclosure is not limited to such a configuration. The cylinder hole of the second cylindrical portion 22 may be in other polygonal shape.

The second inner cylinder 4 is a circular cylindrical member. The second inner cylinder 4 is connected to the sub-frame F by, e.g., bolts (not shown in the figure) inserted into a cylinder hole of the second inner cylinder 4, thereby connecting the second cylindrical portion 22 of the torque rod 1 to the sub-frame F. In such a state, the first inner cylinder 31 is connected to the power plant P, and the second inner cylinder 4 is connected to the sub-frame F. Consequently, the sub-frame F and the power plant P are connected together through the torque rod 1.

In the rubber elastic body 5, through-holes 51, 52 each penetrating the rubber elastic body 5 in a cylinder axis direction of the second inner cylinder 4 (in the vehicle width direction) are formed on both sides of the rubber elastic body 5 in the front-back direction of the vehicle body (in a direction perpendicular to the cylinder axis of the second inner cylinder 4) relative to the second inner cylinder 4, respectively. This forms two main spring portions 53 each extending from the second inner cylinder 4 to the second cylindrical portion 22 in substantially a radial direction.

A stopper 54 is provided on the back side of the vehicle body relative to the through-hole 51, and is part of the rubber elastic body protruding from an inner circumferential surface of the second cylindrical portion 22 toward the front of the vehicle body. On the other hand, a stopper 55 is provided on a front side of the vehicle body relative to the through-hole 52, and is part of the rubber elastic body provided along the inner circumferential surface of the second cylindrical portion 22. The stoppers 54, 55 are provided on the both sides of the rubber elastic body 5 in the main load-input direction (i.e., in the front-back direction of the vehicle body) relative to the second inner cylinder 4, respectively, and each of the stoppers 54, 55 faces the second inner cylinder 4.

As will be described below, when the second inner cylinder 4 and the second cylindrical portion 22 are relatively displaced in the front-back direction of the vehicle body, the stopper 55 comes into contact with the second inner cylinder 4 (the stopper 55 comes into contact with, to be more exact, part of the rubber elastic body 5 surrounding the second inner cylinder 4, and the second inner cylinder 4 and the part of the rubber elastic body 5 surrounding the second inner cylinder 4 may be hereinafter collectively referred to as a “second inner cylinder portion”). Thus, the stopper 55 serves a function to restrict the relative displacement of the second inner cylinder 4 and the second cylindrical portion 22 in the front-back direction of the vehicle body to a predetermined amount.

Specifically, the stopper 55 is provided on part of the inner circumferential surface of the octagonal second cylindrical portion 22 so as to face the second inner cylinder 4 on the front side of the vehicle body and extend along a mounting portion 221 formed so as to be flat in the top-bottom direction of the vehicle body and two surfaces adjoining the mounting portion 221. The stopper 55 includes a first guide portion 551 which is sloped so that an upper part of the first guide portion 551 is on the back side of the vehicle body and a lower part of the first guide portion 551 is on the front side of the vehicle body, and a second guide portion 552 which continues to a lower end of the first guide portion 551 and is sloped in an opposite direction to the slope of the first guide portion 551, i.e., sloped so that an upper part of the second guide portion 552 is on the front side of the vehicle body and a lower part of the second guide portion 552 is on the back side of the vehicle body. Thus, the stopper 55 is formed so as to be recessed from a side closer to the second inner cylinder portion toward the first inner cylinder 31.

The stopper 55 is formed so that the first guide portion 551 and the second guide portion 552 are symmetric to each other with respect to a reference axis A extending in the front-back direction of the vehicle body so as to connect the cylinder axis of the first inner cylinder 31 and the cylinder axis of the second cylindrical portion 22 together. That is, on a side above the reference axis A as viewed in the figure, the first guide portion 551 is sloped from a side farther from the reference axis A (i.e., an upper side as viewed in the figure) toward the reference axis A so as to be apart from the cylinder axis of the second cylindrical portion 22. On the other hand, on a side below the reference axis A as viewed in the figure, the second guide portion 552 is also sloped from a side farther from the reference axis A (i.e., a lower side as viewed in the figure) toward the reference axis A so as to be apart from the cylinder axis of the second cylindrical portion 22. Thus, the second guide portion 552 is sloped in the opposite direction to the slope of the first guide portion 551. The first guide portion 551 and the second guide portion 552 together form substantially a V-shape, and the reference axis A crosses a bottom of the V-shaped stopper 55.

The torque rod 1 is configured as described above, and features and advantages of the torque rod 1 will be described below.

For example, when the automobile is abruptly deaccelerated, a load is input from the power plant P to the torque rod 1 through the first inner cylinder 31 due to great drive reaction force, thereby moving the bracket 2 toward the back of the vehicle body. Since the second inner cylinder 4 is fixed to the sub-frame F, there is little movement of the second inner cylinder 4. As a result, great relative displacement of the second cylindrical portion 22 and the second inner cylinder 4 in the front-back direction of the vehicle body is generated. Then, the second inner cylinder 4 relatively moves on the reference axis A. When the second inner cylinder portion comes into contact with the stopper 55, the second inner cylinder portion contacts the bottom of the V-shaped stopper 55. In such a state, further relative movement of the second cylindrical portion 22 and the second inner cylinder 4 is restricted.

If the load input to the torque rod 1 has components not only in the main load-input direction but also in a direction perpendicular to the main load-input direction, the second inner cylinder 4 relatively moves so as to be deviated from the reference axis A, and therefore the second inner cylinder portion comes into contact with the first guide portion 551 or the second guide portion 552 of the stopper 55.

For example, in a torque rod in which a mounting portion 221 is formed so as to be flat in a top-bottom direction of a vehicle body and sloped first and second guide portions 551, 552 are not provided, when a second inner cylinder portion contacts a stopper 55 in a position deviated from a reference axis A, a bracket 2 may turn about a first cylindrical portion 21. On the other hand, in the torque rod 1, the sloped first and second guide portions 551, 552 are provided. Thus, when the second inner cylinder portion contacts the first or second guide portion 551, 552, the second inner cylinder portion relatively moves toward the reference axis A along the slope of the first or second guide portion 551, 552, and is finally positioned between the first and second guide portions 551, 552 on the reference axis A. This avoids turning of the bracket 2.

As described above, the torque rod 1 is configured so that, when the second inner cylinder portion is deviated from the reference axis A and comes into contact with the stopper 55, the first and second guide portions 551, 552 correct the position of the second inner cylinder 4 to be on the reference axis A. Thus, the turning of the bracket 2 can be avoided. This reduces or prevents displacement by an amount beyond the preset maximum stroke amount, thereby ensuring avoidance of contact of the power plant P with, e.g., other components provided in the engine room.

### Second Example Embodiment

Next, a torque rod 101 of a second example embodiment will be described.

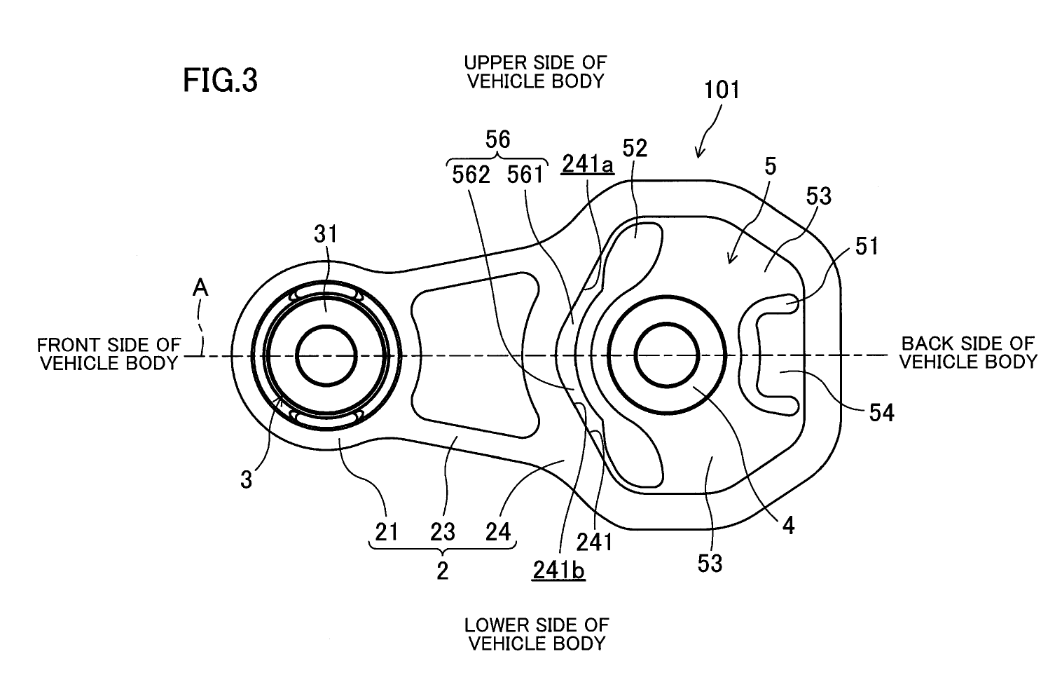

As illustrated in FIG. 3, the torque rod 101 of the second example embodiment is different from that of the first example embodiment in configurations of a second cylindrical portion and a stopper. The same reference numerals as those shown in the first example embodiment are used to represent equivalent elements in the second example embodiment, and the description thereof will not be repeated. The configurations of the second example embodiment different from those of the first example embodiment will be mainly described.

Unlike the torque rod 1 having the mounting portion 221 defining the flat surface in the top-bottom direction of the vehicle body as illustrated in FIG. 2, the torque rod 101 has a mounting portion 241 defining a mounting surface which is sloped on both upper and lower sides of the mounting portion 241 relative to a reference axis A.

Specifically, a second cylindrical portion 24 is formed so as to have a heptagon cylinder hole as viewed from side, and includes the mounting portion 241 which is part of an inner circumferential surface of the heptagon second cylindrical portion 24 and two surfaces of which face a second inner cylinder 4 on a front side of a vehicle body. The mounting portion 241 includes a first mounting surface 241a which, as viewed in the figure, is sloped so that an upper end of the first mounting surface 241 a is on a back side of the vehicle body and a lower end of the first mounting surface 241a is on the front side of the vehicle body, and a second mounting surface 241 b which continues to the lower end of the first mounting surface 241a and is sloped in an opposite direction to the slope of the first mounting surface 241a, i.e., sloped so that an upper end of the second mounting surface 241b is on the front side of the vehicle body and a lower end of the second mounting surface 241 b is on the back side of the vehicle body. Thus, the mounting portion 241 is formed so as to be recessed from a side closer to the second inner cylinder portion toward a first inner cylinder 31.

On a side above the reference axis A as viewed in the figure, the first mounting surface 241 a of the mounting portion 241 is sloped from a side farther from the reference axis A (i.e., the upper side as viewed in the figure) toward the reference axis A so as to be apart from a cylinder axis of the second cylindrical portion 24. On the other hand, on a side below the reference axis A as viewed in the figure, the second mounting surface 241b of the mounting portion 241 is also sloped from a side farther from the reference axis A (i.e., the lower side as viewed in the figure) toward the reference axis A so as to be apart from the cylinder axis of the second cylindrical portion 24. Thus, the first mounting surface 241 a and the second mounting surface 24 lb are symmetric to each other with respect to the reference axis A.

A stopper 56 includes a first sloped portion 561 formed so as to have substantially a uniform thickness on the first mounting surface 241 a and, as a result, sloped in the same direction as the slope of the first mounting surface 241a, and a second sloped portion 562 formed so as to have substantially a uniform thickness on the second mounting surface 241b and, as a result, sloped in the same direction as the slope of the second mounting surface 241b. Thus, the stopper 56 is formed so as to be recessed from the side closer to the second inner cylinder portion toward the first inner cylinder 31.

The torque rod 101 of the second example embodiment is configured as described above, and features and advantages of the torque rod 101 will be described below.

If a load to be input to the torque rod 101 has a component in the top-bottom direction of the vehicle body, the second inner cylinder 4 is deviated from the reference axis A, resulting in relative movement of the second inner cylinder 4. Then, the second inner cylinder portion comes into contact with the first sloped portion 561 or the second sloped portion 562 of the stopper 56.

As in the torque rod 1 illustrated in FIG. 2, since each of the first mounting surface 241a and the second mounting surface 241b of the mounting portion 241 is sloped in the top-bottom direction of the vehicle body, the second inner cylinder portion relatively moves toward the reference axis A along the first mounting surface 241a (first sloped portion 561 of the stopper 56) or the second mounting surface 241b (second sloped portion 562 of the stopper 56), and is finally positioned between the first sloped portion 561 and the second sloped portion 562 on the reference axis A. As a result, in the torque rod 101, turning of a bracket 2 can be avoided, thereby reducing or preventing displacement by an amount beyond the preset maximum stroke amount. Comparison between the torque rod 1 illustrated in FIG. 2 and the torque rod 101 illustrated in FIG. 3 shows the following. In the torque rod 1 illustrated in FIG. 2, the stopper 55 which is part of the rubber elastic body includes the first and second guide portions 551, 552, and the slope of the first or second guide portion 551, 552 is slightly deformed when the stopper 55 contacts the second inner cylinder 4. On the other hand, in the torque rod 101 illustrated in FIG. 3, the slopes of the mounting surfaces 241a, 241b are not deformed, thereby further enhancing a function to reduce or prevent the turning of the bracket 2.

As described above, in the torque rod of each of the foregoing example embodiments, when the second inner cylinder portion is deviated from the reference axis and contacts the stopper, the stopper corrects the position of the second inner cylinder to be on the reference axis. Thus, the turning of the bracket can be avoided, thereby ensuring reduction or prevention of the displacement by the amount beyond the maximum stroke amount.

### Other Embodiment

Each of the foregoing example embodiments may have the following configurations.

That is, in each of the foregoing example embodiments, the second inner cylinder is the circular cylindrical member, but the present disclosure is not limited to such a configuration. The second inner cylinder may be, e.g., an oval cylindrical member.

The first and second guide portions (or the first and second sloped portions) are formed so as to be symmetric to each other with respect to the reference axis, but the present disclosure is not limited to such a configuration. For example, the first and second guide portions (or the first and second sloped portions) may be formed so as to have different angles of slope. The first and second guide portions do not necessarily extend to the reference axis. For example, a recess may be provided in a position of the stopper on the reference axis, and the first and second guide portions may continue to an opening edge of the recess.

The turning of the bracket is likely to occur upon the deceleration of the automobile. Thus, in the torque rod of each of the foregoing example embodiments, the stopper including the first and second guide portions (or the first and second sloped portions) is provided in the rubber elastic body on the front side of the vehicle body relative to the second inner cylinder. However, the stopper may be provided on the back side of the vehicle body in order to obtain the foregoing advantages upon the acceleration of the automobile, or the stoppers may be provided on both of the front and back sides of the vehicle body in order to obtain the foregoing advantages upon the acceleration and deceleration of the automobile.

Claims what is claimed is:

1. A vibration isolator for connecting a supported body and a vehicle body, comprising:
a bracket including
a first cylindrical portion arranged on a side closer to the supported body,
a second cylindrical portion arranged on a side closer to the vehicle body so as to be spaced from the first cylindrical portion in a main load-input direction, and
a connection portion connecting the first and second cylindrical portions;
a first inner cylinder arranged in a cylinder hole of the first cylindrical portion, elastically connected to the first cylindrical portion, and connected to the supported body;
a second inner cylinder arranged in a cylinder hole of the second cylindrical portion so as to be parallel to a cylinder axis of the first inner cylinder and connected to the vehicle body;
a rubber elastic body connecting the second cylindrical portion and the second inner cylinder; and
a stopper provided on a mounting portion which is part of an inner circumferential surface of the second cylindrical portion and faces the second inner cylinder in the main load-input direction, and, when the second cylindrical portion and the second inner cylinder are relatively displaced in the main load-input direction in association with load input, contacting a second inner cylinder portion to restrict relative displacement of the second cylindrical portion and the second inner cylinder,
wherein the stopper includes
a first guide portion which, on one side in a direction perpendicular to the main load-input direction relative to a reference axis extending in the main load-input direction so as to connect the cylinder axis of the first inner cylinder and a cylinder axis of the second cylindrical portion together, extends from a side farther from the reference axis toward the reference axis so as to be apart from the cylinder axis of the second cylindrical portion and is sloped to the direction perpendicular to the main load-input direction, and
a second guide portion which, on the other side in the direction perpendicular to the main load-input direction relative to the reference axis, is sloped to the direction perpendicular to the main load-input direction in an opposite direction to a slope of the first guide portion, and
when the second inner cylinder portion contacts the first or second guide portion of the stopper in association with the load input, the second inner cylinder portion relatively moves toward the reference axis along the first or second guide portion.

2. A vibration isolator for connecting a supported body and a vehicle body, comprising:
a bracket including
a first cylindrical portion arranged on a side closer to the supported body,
a second cylindrical portion arranged on a side closer to the vehicle body so as to be spaced from the first cylindrical portion in a main load-input direction, and
a connection portion connecting the first and second cylindrical portions;
a first inner cylinder arranged in a cylinder hole of the first cylindrical portion, elastically connected to the first cylindrical portion, and connected to the supported body;
a second inner cylinder arranged in a cylinder hole of the second cylindrical portion so as to be parallel to a cylinder axis of the first inner cylinder and connected to the vehicle body;
a rubber elastic body connecting the second cylindrical portion and the second inner cylinder; and
a stopper provided on a mounting portion which is part of an inner circumferential surface of the second cylindrical portion and faces the second inner cylinder in the main load-input direction, and, when the second cylindrical portion and the second inner cylinder are relatively displaced in the main load-input direction in association with load input, contacting a second inner cylinder portion to restrict relative displacement of the second cylindrical portion and the second inner cylinder,
wherein the mounting portion includes
a first mounting surface which, on one side in a direction perpendicular to the main load-input direction relative to a reference axis extending in the main load-input direction so as to connect the cylinder axis of the first inner cylinder and a cylinder axis of the second cylindrical portion together, extends from a side farther from the reference axis toward the reference axis so as to be apart from the cylinder axis of the second cylindrical portion and is sloped to the direction perpendicular to the main load-input direction, and
a second mounting surface which, on the other side in the direction perpendicular to the main load-input direction relative to the reference axis, is sloped to the direction perpendicular to the main load-input direction in an opposite direction to a slope of the first mounting surface,
the stopper is provided along the first and second mounting surfaces, and
when the second inner cylinder portion contacts the stopper in association with the load input, the second inner cylinder portion relatively moves toward the reference axis along the first or second mounting surface.

3. The vibration isolator of claim 1, wherein
the second inner cylinder, the second cylindrical portion, and the rubber elastic body are formed by integral vulcanization molding.

4. The vibration isolator of claim 2, wherein
the second inner cylinder, the second cylindrical portion, and the rubber elastic body are formed by integral vulcanization molding.
